(19) United States
(12) Patent Application Publication
(10) Pub. No.: US 2018/0351404 A1
(43) Pub. Date: Dec. 6, 2018

(54) HIGHLY EFFICIENT SELF-POWERED WIRELESS SENSOR AND MODULE

(71) Applicants: Youngmin Kim, Seoul (KR); Towoo Lim, Seoul (KR)

(72) Inventors: Youngmin Kim, Seoul (KR); Towoo Lim, Seoul (KR)

(21) Appl. No.: 15/997,661

(22) Filed: Jun. 4, 2018

(30) Foreign Application Priority Data
Jun. 5, 2017 (KR) 10-2017-0069468
Jun. 4, 2018 (KR) 10-2018-0064285

(51) Int. Cl. H02J 50/10; H02M 7/217; H04W 4/80; G01D 11/00

(52) U.S. Cl. CPC H02J 50/10; H02M 7/217; H04W 84/18; G01D 11/00; H04W 4/80

(57) ABSTRACT

Disclosed is a self-powered wireless sensor and sensor module. The wireless sensor and sensor module includes a harvesting circuit configured to collect power from an external environment, a sensor unit configured to comprise one or more sensors, a controller configured to store data collected by the sensor unit, and a wireless communication unit configured to transmit the sensor data stored in the controller to a destination. The harvesting circuit may include a voltage doubler. Accordingly, output voltage efficiency of the wireless sensor and sensor module can be improved.

### CROSS REFERENCE TO RELATED APPLICATION

The present application claims the benefit of Korean Patent Applications No. 10-2017-0069468 and No. 10-2018-0064285 filed in the Korean Intellectual Property Office on Jun. 5, 2017 and Jun. 4, 2018, the entire contents of which are incorporated herein by reference.

### BACKGROUND OF THE INVENTION

### 1. Technical Field

The present invention relates to a wireless sensor and sensor module and, more particularly, to a high efficiency and self-powered wireless sensor and sensor module.

### 2. Description of the Related Art

As the electric power supply and demand volatility increases due to the introduction of renewable energy and the expansion of the electric vehicle market, an increase of stress of a power system and the possibility that a power system may malfunction have increased.

In order to secure reliability and high efficiency of the power system, the real-time monitoring of a power facility is essentially required.

A real-time power system monitoring technology has been in the spotlight as a core technology in realizing the smart grid, but is used in a very limited area on the spot due to the installation of a sensor module and a burden of a maintenance cost. A commercialized smart sensor has lots of practical difficulties in being installed in a power facility because it is expensive and heavy.

Furthermore, the real-time monitoring of a massive power network is not realized due to frequent replacement of a battery used in a sensor.

### SUMMARY OF THE INVENTION

Accordingly, an embodiment of the present invention provides a self-powered wireless sensor and sensor module which can significantly reduce a maintenance cost for the wireless sensor and sensor module by adopting the energy harvesting technology capable of replacing a battery necessary for a wireless sensor.

An embodiment of the present invention is to provide a self-powered wireless sensor and sensor module capable of significantly reducing a maintenance cost for a sensor.

An embodiment of the present invention is to provide a self-powered wireless sensor and sensor having an energy harvesting circuit of improved magnetic field collection efficiency and a lower power autonomous switching circuit.

A wireless sensor and sensor module according to an embodiment of the present invention includes a harvesting circuit configured to collect magnetic energy from an external environment, a sensor unit configured to include one or more sensors, a controller configured to store data collected by the sensor unit, and a wireless communication unit configured to transmit the sensor data stored in the controller to a destination. The harvesting circuit may include a voltage doubler.

Furthermore, the harvesting circuit may include a rectifier and an energy storage unit.

Furthermore, the energy storage unit may include a capacitor.

Furthermore, the wireless sensor and sensor module may further include an autonomous switching circuit positioned between the harvesting circuit and the controller to transfer energy collected by the harvesting circuit to the controller, the sensor unit and the wireless communication unit.

### BRIEF DESCRIPTION OF THE DRAWINGS

FIG. 1 is a block diagram of a wireless sensor according to an embodiment of the present invention.

FIG. 2 shows a harvesting circuit according to an embodiment of the present invention.

FIG. 3 shows a wireless sensor including an autonomous switching circuit according to an embodiment of the present invention.

FIG. 4 shows a harvesting circuit according to a first comparison example.

FIG. 5 shows a harvesting circuit according to a second comparison example.

FIG. 6 is a graph showing the output voltage of the harvesting circuit when the same magnetic field-induced voltage is received.

<Description of reference numerals>

| 2: rectifier | 4: energy storage unit |
|---|---|
| 10: harvesting circuit | |
| 20: controller | 30: sensor unit |

40: wireless communication unit
50: autonomous switching circuit

### DETAILED DESCRIPTION

The details of the objects and technological configurations of the present invention and acting effects thereof will be more clearly understood from the following detailed description based on the accompanying drawings. In the description of the present invention, when it is said that each layer (or film), area, pattern or structure is formed “over/on” or “under/below” each substrate, layer (or film), area, pad or structure, this includes both expressions, including that one element is directly formed on the other element and that a third element is interposed between the two elements. A criterion for the term “over/on” or “under/below” of each layer is described based on the drawings.

Terms, such as “the first” and “the second”, are merely used to distinguish between the same or corresponding elements, and the same or corresponding elements are not restricted by terms, such as “the first” and “the second.”

An expression of the singular number includes an expression of the plural number unless clearly defined otherwise in the context. A term, such as “include (or comprise)” or “have”, is intended to designate the presence of a characteristic, number, step, operation, element or part described in the specification or a combination of them, and may be construed as including one or more other characteristics, numbers, steps, operations, elements, parts or combinations of them.

Hereinafter, embodiments of the present invention are described in detail with reference to the accompanying drawings.

FIG. 1 is a block diagram of a wireless sensor according to an embodiment of the present invention.

As shown in FIG. 1, the wireless sensor according to an embodiment of the present invention may include a harvesting circuit 10, a sensor unit 30, a controller 20 and a wireless communication unit 40.

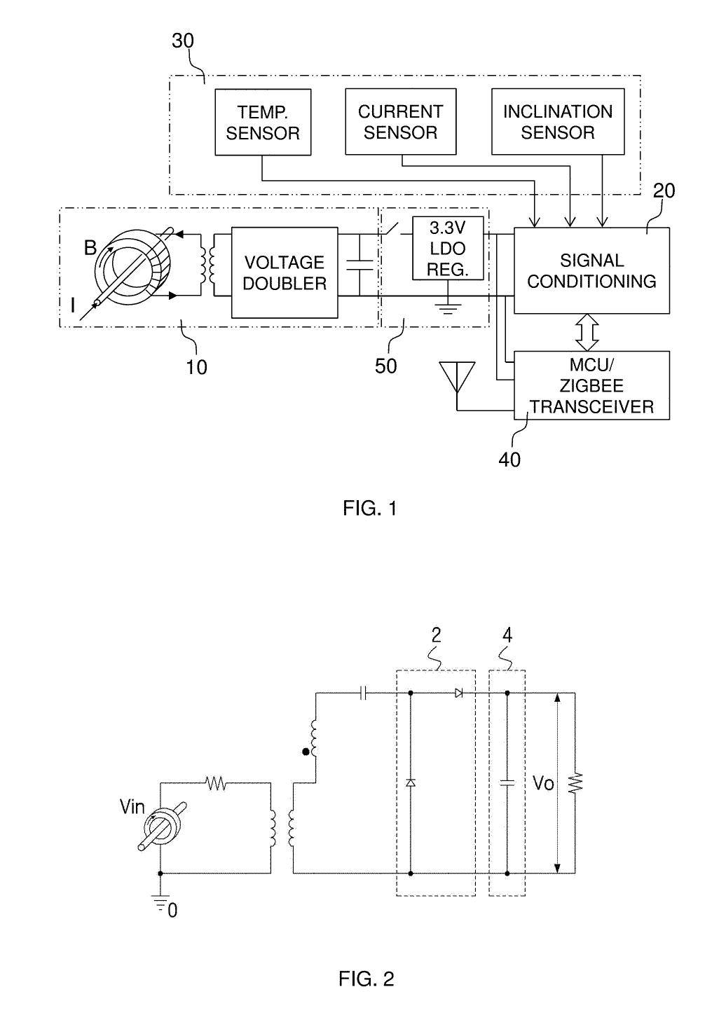

The harvesting circuit 10 is described in detail with reference to FIGS. 1 and 2.

The harvesting circuit 10 may include an energy rectifier 2 and an energy storage unit 4.

Power collected from a surrounding environment by the harvesting circuit 10 is converted into a DC voltage through the energy rectifier 2. The converted voltage may be stored in the energy storage unit 4.

The harvesting circuit 10 may include a voltage doubler.

Furthermore, the harvesting circuit 10 according to an embodiment of the present invention may collect a peak-to-peak voltage through a combination of a diode and a capacitor.

Energy collected from a surrounding environment by the harvesting circuit 10 may be stored in the energy storage unit 4. The stored energy may become the power source for circuits that obtains and transmits data, such as a microcontroller, the wireless communication circuit 40 and the sensor unit 30.

The energy storage unit 4 needs to have a low leakage current. The reason for this is that although energy is stored in the energy storage unit 4, the energy is discharged before it is used if the leakage current is high.

The energy storage unit 4 may include a capacitor, and capacitance of the capacitor may be determined depending on an application field. The capacitance of the capacitor may be selected by taking into consideration the size of a wireless sensor because the size of the wireless sensor also increases if the capacitance of the capacitor increases.

For example, if energy is collected through the harvesting circuit 10 in a distribution line, energy collected while the distribution line normally operates may be stored in the energy storage unit 4. Furthermore, if the collection of energy is impossible due to the power failure of the distribution line, a warning message may be transmitted to a facility control room several times.

If the output terminal of the harvesting circuit 10 is directly connected to the energy storage unit 4 formed of the capacitor, a drop problem may occur in an output voltage. In order to avoid this problem, the energy storage unit 4 may be connected to the output terminal of the harvesting circuit 10 through a diode and a transistor so that energy is stored only when a constant output voltage is maintained.

The energy rectifier 2 converts an AC voltage, collected through the harvesting circuit 10, into a DC voltage.

The energy rectifier 2 is illustrated as being a full-wave rectifier including two diodes, but the present invention is not limited thereto. Various forms of rectifiers may be used as the energy rectifier.

The voltage converted by the energy rectifier 2 may be stored in the energy storage unit 4 or may be used as energy necessary for the sensor unit 30 or the wireless communication unit 40.

The sensor unit 30 may include one or more sensors and may collect data through sensors.

The sensors may include various sensors, such as a temperature sensor, a tilt sensor, a current sensor, or an acceleration sensor.

For example, in the case of a wireless sensor applied to the monitoring of a distribution line, an infrared temperature sensor may be used as the temperature sensor in order to precisely measure a surface temperature of the distribution line.

The tilt sensor may use the tilt of the distribution line. A 3-axis tilt sensor capable of measuring a 3-axis tilt may be used as the tilt sensor. The 3-axis tilt sensor may sense an unstable movement of the distribution line in real time, thereby being capable of preventing and diagnosing a facility before the facility is greatly damaged.

The controller 20 may store sensor data collected by the sensor unit 30, and may transmit the stored sensor data to a destination where sensor data is collected every given time or given cycle through the wireless communication unit 40.

A micro control unit (MCU) and the wireless communication unit 40 may control and transmit the sensor data stored in the controller 20 to the destination.

The wireless communication unit 40 may include the microcontroller. The microcontroller may control data transmitted by the controller 20 and collected by the sensor unit 30.

The wireless communication unit 40 may transmit the sensor data to a server or an operating system over a wireless communication network.

The wireless communication unit 40 may use a commercial wide area communication network, such as 3G or 4G, or a short-distance communication network, such as Wi-Fi.

The short-distance wireless communication is not limited to Wi-Fi. Short-distance wireless communication, such as Bluetooth or Zigbee communication, may be selectively used, if necessary.

An autonomous switching circuit 50 may be positioned between the harvesting circuit 10 and the controller 20.

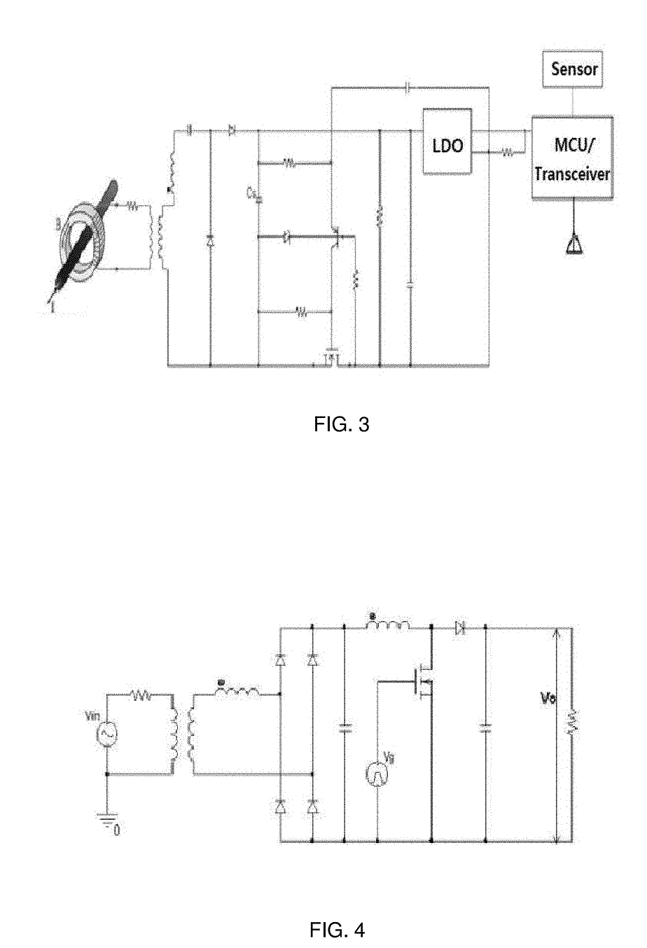

FIG. 3 shows the autonomous switching circuit 50 connected to the harvesting circuit 10. Since available magnetic energy is very limited, an induced voltage from coils is often insufficient to turn on diodes or transistors, requiring an efficient power management circuit to run MCU and sensors. Using the autonomous switching circuit the sensor module operates in two modes, sleep mode and active mode. In a sleep mode magnetic energy is collected on a storage capacitor while the sensors and MCU are disconnected from the capacitor. Upon reaching to a pre-specified energy level, the autonomous switching circuit starts to provide the energy to the sensors and MCU, becoming an active mode. When the stored energy is consumed and drops below a pre-specified energy level, the autonomous switching circuit disconnects the storage capacitor from the sensors and MCU and operates in the sleep mode again.

The autonomous switching circuit 50 may be implemented using a MOSFET, a BJT transistor and a low drop out regulator (LDO). To minimize turn-on voltage drop of devices in the circuit, low voltage diode and transistors are used.

The harvesting circuit 10 according to an embodiment of the present invention is described in detail with reference to FIGS. 2, 4 and 5.

FIG. 4 shows a harvesting circuit according to a first comparison example. The harvesting circuit has a combination of a diode bridge and a DC-DC converter. The harvesting circuit according to the first comparison example is suitable for collecting a symmetrical voltage, but has a problem in that it has low efficiency if it collects an irregular and asymmetrical voltage.

Furthermore, the harvesting circuit according to the first comparison example may have a difficulty in maintaining a circuit operation in an environment in which a low and irregular voltage is supplied due to the circuit complexity of the DC-DC converter.

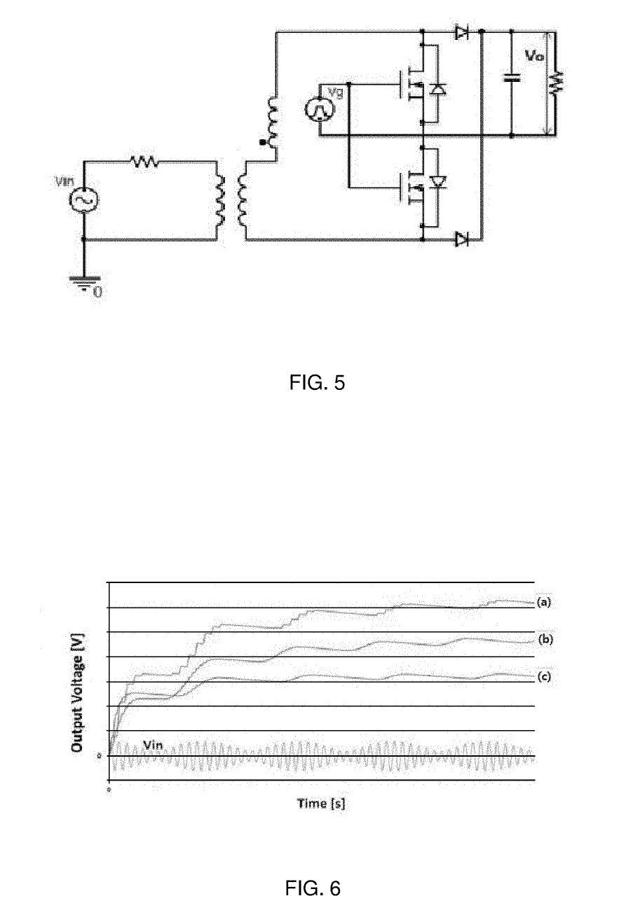

FIG. 5 shows a harvesting circuit according to a second comparison example. The harvesting circuit according to the first comparison example may be implemented more simply by integrating a DC converter and a bridge circuit.

The harvesting circuit according to the second comparison example may have a higher output voltage than the harvesting circuit according to the first comparison example because it can reduce a voltage necessary when a device is turned on.

The harvesting circuit according to the first and the second comparison examples requires a converter that efficiently drops a voltage while securing a wide input voltage range because it outputs energy of a high voltage value. The harvesting circuit that outputs a very low voltage needs to have a given size or more because it may include a converter that efficiently boosts a voltage up to a given voltage. Accordingly, the harvesting circuit has lots of difficulties in reducing the size and weight of the wireless sensor.

Furthermore, the harvesting circuit according to the first and the second comparison examples may have a difficulty in raising conversion efficiency if the width of a corresponding input voltage is wide or an absolute value of an input voltage is extremely small.

As shown in FIG. 2, the harvesting circuit 10 according to an embodiment of the present invention can improve output conversion efficiency by removing a voltage boosting converter.

The harvesting circuit 10 according to an embodiment of the present invention may be implemented based on the voltage doubler. The harvesting circuit 10 according to an embodiment of the present invention can be simplified based on the voltage doubler compared to the harvesting circuit according to the first and the second comparison examples.

Furthermore, a complicated gate drive circuit is not necessary by removing the voltage boosting converter, and power consumed for the operations of the MOSFET and the gate pulse voltage generator can be converted into output power and collected.

Accordingly, since energy can be efficiently collected even at a low voltage derived from a magnetic field, energy collection efficiency can be significantly improved, an output voltage can be increased, and the operating time of the wireless sensor can be increased.

Furthermore, the size and weight of the wireless sensor can be reduced because a transformer coil ratio at the input terminal of the harvesting circuit 10 connected to a current transformer CT can be reduced by applying the harvesting circuit 10 according to an embodiment of the present invention.

FIG. 6 is a graph showing output voltages of the harvesting circuits according to the first and the second comparison examples and the harvesting circuit according to an embodiment of the present invention when the same magnetic field-induced voltage is received.

The output voltage of the harvesting circuit according to an embodiment of the present invention is defined as “a.” The output voltage of the harvesting circuit according to the first comparison example is defined as “b.” The output voltage of the harvesting circuit according to the second comparison example is defined as “c.”

From a comparison between the output voltage “a” of the harvesting circuit according to an embodiment of the present invention and the output voltage “b” of the harvesting circuit according to the first comparison example, it may be seen that the output voltage “a” of the harvesting circuit according to an embodiment of the present invention is 100% higher than the output voltage “b” of the harvesting circuit according to the first comparison example.

From a comparison between the output voltage “a” of the harvesting circuit according to an embodiment of the present invention and the output voltage “c” of the harvesting circuit according to the second comparison example, it may be seen that the output voltage “a” of the harvesting circuit according to an embodiment of the present invention is 30% higher than the output voltage “c” of the harvesting circuit according to the second comparison example.

As described above, it may be seen that the output voltage is increased because energy collection efficiency is significantly improved through the harvesting circuit 10 according to an embodiment of the present invention.

The wireless sensor according to an embodiment of the present invention can be produced into a small-sized module because a voltage boosting converter is removed and thus a MOSFET and a gate voltage generation circuit are not necessary.

Furthermore, the size and weight of a wireless sensor circuit can be reduced and a light-weight wireless sensor module can be fabricated because a transformer coil ratio at the input terminal of the harvesting circuit 10 can be reduced by applying the harvesting circuit 10 according to an embodiment of the present invention.

The wireless sensor and module according to an embodiment of the present invention may be applied to many fields. Specifically, the wireless sensor and module may be applied to a power transmission and distribution line, a power system, etc. and may be applied to a wireless sensor that is dangerous like a high-voltage power-line tower in a mountainous area and whose battery replacement is difficult. Accordingly, a problematic situation can be prevented by sensing the aging of a transmission distribution line.

Furthermore, the wireless sensor and module according to an embodiment of the present invention can be widely applied to areas where a sensor cannot be installed due to existing power problems, such as an environment surveillance device capable of monitoring a fire and a landslide in a danger area, industrial surveillance devices, and the surveillance device of a facility at a safety blind spot, for example, a bridge and structure. Accordingly, an accident can be prevented through monitoring before a problematic situation, such as disaster damage, occurs.

Furthermore, the wireless sensor and module according to an embodiment of the present invention can be applied to real-time data monitoring fields, such as building automation and factory automation.

If the wireless sensor according to an embodiment of the present invention is applied, energy can be supplied through the sensor itself and a battery can be driven although it is not replaced or not connected through a wire. That is, an installation and maintenance cost can be greatly reduced, and the wireless sensor can be installed even in an area whose periodical replacement is difficult or a dangerous area.

Output voltage efficiency can be improved through the wireless sensor according to an embodiment of the present invention.

Furthermore, according to an embodiment of the present invention, the size and weight of the wireless sensor can be reduced.

Furthermore, according to an embodiment of the present invention, the operating time of the wireless sensor can be increased.

Furthermore, according to an embodiment of the present invention, a maintenance cost for the sensor can be significantly reduced.

What is claimed is:

1. A wireless sensor and sensor module, comprising:
a harvesting circuit configured to collect power from an external environment;
a sensor unit configured to comprise one or more sensors;
a controller configured to store data collected by the sensor unit; and
a wireless communication unit configured to transmit the sensor data stored in the controller to a destination,
wherein the harvesting circuit comprises a voltage doubler.

2. The wireless sensor and sensor module of claim 1, wherein the harvesting circuit comprises a rectifier and an energy storage unit.

3. The wireless sensor and sensor module of claim 1, wherein an input terminal of the harvesting circuit connects to a transformer.

4. The wireless sensor and sensor module of claim 1, further comprising an autonomous switching circuit positioned between the harvesting circuit and the controller to transfer energy obtained by the harvesting circuit to the controller, the sensor unit and the wireless communication unit.
